(19) United States
(12) Patent Application Publication
(10) Pub. No.: US 2008/0198369 A1
(43) Pub. Date: Aug. 21, 2008

(54) Interferometer air-fluctuation monitors and systems comprising same

(75) Inventor: Michael R. Sogard, Menlo Park, CA (US)

Correspondence Address: KLARQUIST SPARKMAN, LLP, 121 SW SALMON STREET, SUITE 1600, PORTLAND, OR, 97204, US

(73) Assignee: Nikon Corporation

(21) Appl. No.: 12/070,016

(22) Filed: Feb. 13, 2008

Related U.S. Application Data
(60) Provisional application No. 60/901,402, filed on Feb. 14, 2007.

(51) Int. Cl. G01N 21/00

(52) U.S. Cl. 356/73

(57) ABSTRACT

Sensors and monitors are disclosed for monitoring density fluctuations in an atmosphere, particularly an atmosphere through which interferometer beam(s) are propagating. An exemplary sensor includes multiple interferometers that produce respective beams propagating in a direction through the atmosphere. The interferometers are of a quantity that is at least one more than necessary for determining position of an object in the direction. A processor is connected to the interferometers so as to receive respective signals from the interferometers. The processor determines, from the interferometer signals, a mutual signal fluctuation that is a function of atmosphere-density fluctuations encountered by the propagating beams in their respective beam paths and sensed by the interferometers.

### CROSS REFERENCE TO RELATED APPLICATION

This application claims priority from, and the benefit of, U.S. Provisional Application No. 60/901,402 filed on Feb. 14, 2007, which is incorporated herein by reference in its entirety.

### FIELD

This disclosure pertains to, inter alia, optical systems in which extremely accurate positioning is performed. Examples of such a system are any of various precision-exposure systems, such as inspection systems, metrology systems, and microlithography systems. Microlithography is a key imaging technology used in the manufacture of semiconductor micro-devices, displays, and other products having fine structure that can be fabricated by processes that include microlithographic imprinting. More specifically, the disclosure pertains to interferometry as used for determining position of any of various moving objects, such as stages and the like. Even more specifically, the disclosure pertains to monitoring and/or controlling air-density fluctuations in interferometer beam paths to achieve more accurate positional determinations by the interferometers.

### BACKGROUND

The proper functioning of various systems and apparatus relies upon an ability to position an object, such as a workpiece, accurately and precisely, such as relative to a machining tool, processing tool, or imaging device. Object placement is perhaps most critical in lithographic exposure systems used in the fabrication of microelectronic devices, displays, and the like. These systems, called microlithography systems, must satisfy extremely demanding criteria of image-placement, image-resolution, and image-registration on the lithographic substrate. For example, to achieve currently demanded feature sizes, in projected images, of 100 nm or less on the substrate, placement of the substrate for exposure must be accurate at least to within a few nanometers or less. Such criteria place enormous technical demands on stages and analogous devices used for holding and moving the substrate and for, in some systems, holding and moving a pattern-defining body such as a reticle or mask.

The current need for stages capable of providing extremely accurate placement and movement of reticles, substrates, and the like has been met in part by using laser interferometers for determining stage position. Microlithography systems typically use at least two perpendicular sets of interferometer beams to measure the horizontal (x-y) two-dimensional position of each x-y stage of the system. The stages and their respective interferometer systems are enclosed in an environmental chamber containing a flow of highly filtered and temperature-controlled air. The air flow serves in part to prevent deposition of particulate matter on the lithographic substrate or on the reticle. In addition, local air ducts are often provided in proximity to the interferometer beams, to achieve further improvements in air-temperature stability. Thus, the environmental chamber assists in maintaining the index of refraction of the air at a substantially constant value by maintaining constancy of the air temperature.

However, the air in the chamber is not perfectly isothermal. Air experiencing a change in temperature exhibits a corresponding change in density and refractive index. Typical air-flow conditions in the chamber result in turbulent flow. Turbulent mixing of air in the environmental chamber with air from the local ducts can create air of variable temperature in the interferometer beams. The mixture of air temperatures resulting from the turbulence changes the optical path lengths of interferometer beams, and thus degrades the accuracy and precision of stage-positional measurements determined by the interferometers.

The turbulent mixing of air creates “cells” of air of different density that flow though the interferometer beams. The temperature variations in these cells can be quite small while still having an adverse effect on the interferometer beam. For example, air-temperature fluctuations of a few millikelvins can produce corresponding discrepancies of several nanometers in the positional determinations made by an interferometer, which is significant in microlithography. Measuring such small air-temperature fluctuations, especially with the aim of eliminating or reducing them, is difficult. The total effect of these fluctuations on the interferometer signal is equal to the cumulative contribution of all fluctuations along the interferometer beam path. Thus, the effect of the fluctuations will in general have some dependence on stage position. Accurate measurement of these fluctuations could lead in principle to improved air-flow control and reduced interferometer fluctuations.

Aside from air temperature, there are also other sources of variation or fluctuation in interferometer data. These other sources can include acoustic noise, mechanical vibrations, changes in air composition, or changes in ambient temperature or barometric pressure. In a well-designed microlithography system, noise and vibration components usually are minimized. Certain changes in air composition or ambient conditions tend to occur relatively slowly, and tend to be relatively homogeneous. These changes usually can be successfully monitored at point locations, allowing calculations of corrections to be made to the interferometer path length. Other changes to air composition are not easily monitored and corrected. Even though this disclosure is set forth in the context of air-temperature fluctuations in the interferometer beam path, it will be understood that the principles disclosed herein are also applicable to other sources of fluctuations in interferometer beam paths.

In view of the foregoing, there is a need for obtaining more accurate fluctuation data along the beam path over an extended distance. There is also a need for using such fluctuation data to achieve better control of the conditions along the beam path and thus to achieve better movement and positional control of the object being monitored by the interferometer.

### SUMMARY

The foregoing needs are addressed by various embodiments as disclosed herein. The embodiments encompass multiple aspects of the invention.

According to a first aspect, sensors of density fluctuations in an atmosphere are provided. An embodiment of such a sensor comprises multiple interferometers producing respective beams propagating in a direction through an atmosphere. The interferometers are of a quantity that is at least one more than necessary for determining position of an object in the direction. The embodiment also includes a processor connected to the interferometers so as to receive respective signals from the interferometers. The processor is configured to determine, from the interferometer signals, a mutual signal fluctuation that is a function of atmosphere-density fluctuations encountered by the propagating beams in their respective beam paths and sensed by the interferometers.

The beams can be arranged to propagate in the direction to an object in the direction. A mirror can be situated on the object to reflect the interferometer beams.

The interferometers can comprise a first and a second interferometer, wherein the first interferometer is situated and configured to determine the position of the object in the direction, and the second interferometer is a redundant interferometer. In such an embodiment the processor desirably is configured to determine the mutual signal fluctuation from the respective signals from the first and second interferometers. For example, the mutual signal fluctuation can be DX₂=I₁−I₂=δ₁−δ₂, in which I₁ is the signal from the first interferometer, I₂ is the signal from the second interferometer, and δ₁ and δ₂ are respective density fluctuations in the respective beam paths of the first and second interferometers. The first and second interferometers can be situated and configured to determine position and yaw of the object.

In another embodiment, the interferometers comprise a first, a second, and a third interferometer, wherein the first and second interferometers are situated and configured to determine the position of the object in the direction, and the third interferometer is a redundant interferometer. In this embodiment the processor can be configured to determine the mutual signal fluctuation from the respective signals from the first, second, and third interferometers. For example, the mutual signal fluctuation can be DX₃=I₁+I₃−2I₂=δ₁+δ₃−2δ₂, in which I₁ is the signal from the first interferometer, I₂ is the signal from the second interferometer, I₃ is the signal from the third interferometer, and δ₁, δ₂, and δ₃ are respective density fluctuations in the respective beam paths of the first, second, and third interferometers.

In certain embodiments the beams are parallel to, and equally spaced from, each other. For example, the beams can be situated in a plane.

According to another aspect, devices are provided for determining a position of an object that is movable in a direction. An embodiment of such a device comprises a mirror, multiple interferometers, and a processor. The mirror is mounted to the object. Respective beams of the multiple interferometers propagate in a direction through an atmosphere to the mirror. The interferometers are of a quantity that is at least one more than necessary for determining position of the object in the direction. The processor is connected to the interferometers and is configured to: (a) receive respective signals from the interferometers; (b) determine, from the interferometer signals, the position of the object in the direction; (c) determine, from the interferometer signals, a mutual signal fluctuation that is a function of atmosphere-density fluctuations encountered by the beams and sensed by the interferometers; and (d) based on the mutual signal fluctuation, remove effects of atmosphere-density fluctuations on the determined position.

The interferometers can comprise first and second interferometers, wherein the first interferometer is situated and configured to determine position of the object in the direction, and the second interferometer is a redundant interferometer. The respective beams of the first and second interferometers can be situated to determine position and yaw of the object. In another embodiment the interferometers comprise first, second, and third interferometers, wherein the first and second interferometers are situated to determine the position of the object in the direction, and the third interferometer is a redundant interferometer.

In certain embodiments the device further comprises an air-flow device configured to release a flow of air across the interferometer beams. The air-flow device can be configured to release the flow of air at a right angle to the direction.

According to yet another aspect, exposure systems are provided. An embodiment of such a system comprises an optical system, a stage, multiple interferometers, and a processor. The stage is movable in a direction relative to the optical system. The interferometers produce respective beams that propagate in the direction through an atmosphere to the stage; the interferometers are of a quantity that is at least one more than necessary for determining position of the stage in the direction. The processor is connected to the interferometers so as to receive respective signals from the interferometers. The processor is configured to determine, from the interferometer signals, a mutual signal fluctuation that is a function of atmosphere-density fluctuations encountered by the propagating beams in their respective beam paths and sensed by the interferometers. An exemplary system is a microlithography system.

The system can further comprise a mirror mounted to the stage, wherein the beams propagating in the direction reflect from the mirror. In such embodiments the processor can be further configured to remove, based on the mutual signal fluctuation, effects of atmosphere-density fluctuations on the determined position of the stage.

According to yet another aspect, methods are provided for monitoring an interferometer-beam path for fluctuations in density of an atmosphere in the path. In an embodiment of such a method, respective interferometer beams from multiple interferometers are directed in a direction through the atmosphere to an object. The interferometers are of a quantity that is at least one more than necessary for determining a position of the object in the direction. From respective signals from the interferometers, a mutual signal fluctuation is determined. The mutual signal fluctuation is a function of atmosphere-density fluctuations encountered by the propagating beams and sensed by the interferometers.

Certain embodiments of the method can further comprise determining the position of the object using a first interferometer, and using a second interferometer as a redundant interferometer for determining the position. In other embodiments the position of the object is determined using first and second interferometers, wherein a third interferometer is used as a redundant interferometer for determining the position.

According to another aspect, methods are provided for determining a density fluctuation in an atmosphere in an interferometer-beam path. In an embodiment of the method respective interferometer beams from multiple interferometers are propagated in a direction through the atmosphere to an object that is movable in the direction. The interferometers are of a quantity that is at least one more than necessary for determining a position of the object in the direction. From respective signals from the interferometers, a mutual signal fluctuation is determined that is a function of atmosphere-density fluctuations encountered by the propagating beams and sensed by the interferometers.

According to yet another aspect, methods are provided for correcting a signal fluctuation due to a density variation in an atmosphere in an optical path of an interferometer device for measuring position of an object that is movable in a direction. An embodiment of the method comprises propagating respective beams of multiple interferometers in the direction through the atmosphere to the object. The multiple interferometers are of a quantity that is at least one more than necessary for determining a position of the object in the direction. Respective positional signals are received from the interferometers, and a preliminary position of the object is determined from the signals. From the positional signals, a mutual signal fluctuation is determined that is a function of atmosphere-density fluctuations encountered by the beams and sensed by the interferometers. The mutual signal fluctuation is subtracted from the preliminary signal to produce an actual-position signal.

Yet another aspect is directed, in the context of an exposure system including an optical system, a stage that is movable in a direction relative to the optical system, and an interferometer device for measuring position of the stage in the direction, to methods for correcting an error of the stage position determined by the interferometer device resulting from a density variation in an atmosphere in an optical path of the interferometer system. An embodiment of such a method comprises propagating multiple beams of the interferometer device in the direction through the atmosphere to the stage; the beams are of a quantity that is at least one more than necessary for determining stage position in the direction. Respective positional signals are received from each of the beams of the interferometer device. From the positional signals, a mutual signal fluctuation is determined that is a function of atmosphere-density fluctuations encountered by the beams and sensed by the interferometer device. Based on the mutual signal fluctuation and the positional signals, the stage position is determined that is corrected for the atmosphere-density fluctuations.

The foregoing and additional features and advantages of the invention will be more readily apparent from the following detailed description, which proceeds with reference to the accompanying drawings.

### BRIEF DESCRIPTION OF THE DRAWINGS

FIG. 1 is a schematic plan view of a stage configured to move in one dimension (x-direction) and utilizing three interferometers for measuring displacement and yaw.

FIG. 2(A) is a plot of two respective interferometry signals (I₁ and I₂) generated from a model involving multiple sinusoidal components, as an example of strongly correlated signals produced by the two interferometers.

FIG. 2(B) is a plot of the signal DX₂ for the signals in FIG. 2(A).

FIG. 3(A) is a plot of two respective interferometry signals (I₁ and I₂) for arbitrary air-flow conditions, as an example of weakly correlated signals produced by the two interferometers.

FIG. 3(B) is a plot of the signal DX₂ for the signals in FIG. 3(A).

FIG. 4 is a schematic elevational diagram of certain portions of an exemplary microlithography system.

FIG. 5 is a schematic diagram, for comparison purposes, of a conventional air-handling system for a microlithography system that comprises an environmental chamber.

FIG. 6 is a schematic diagram of an embodiment of an air-handling system.

FIG. 7(A) is a plot of data, along the x-direction, showing the results of adjusting the temperature of the air in the local laminar (LL) air duct very finely to the temperature of air in the environmental chamber, thereby minimizing air-density fluctuations in the interferometer beams.

FIG. 7(B) is a plot of data, along the y-direction, showing the results of adjusting the temperature of the air in the LL air duct very finely to the temperature of air in the environmental chamber, thereby minimizing air-density fluctuations in the interferometer beams.

FIG. 8 is an elevational schematic diagram showing certain aspects of an exemplary exposure system that includes at least one of the embodiments disclosed herein.

FIG. 9 is a block diagram of an exemplary semiconductor-device fabrication process that includes wafer-processing steps including a lithography step.

FIG. 10 is a block diagram of a wafer-processing process as referred to in FIG. 9.

### DETAILED DESCRIPTION

This disclosure is set forth in the context of multiple representative embodiments that are not intended to be limiting in any way.

In the following description certain words are used, such as “upward,” “downward,” “vertical,” “horizontal,” and the like. These words are used to provide clarity of the descriptions when read in the context of the drawings. Whereas these words are useful in understanding relative relationships, they are not intended to be limiting. For example, an object depicted in a drawing readily can be turned upside down, resulting in an “upper” surface becoming a “lower” surface, and vice versa. Nevertheless, the object is still the same object.

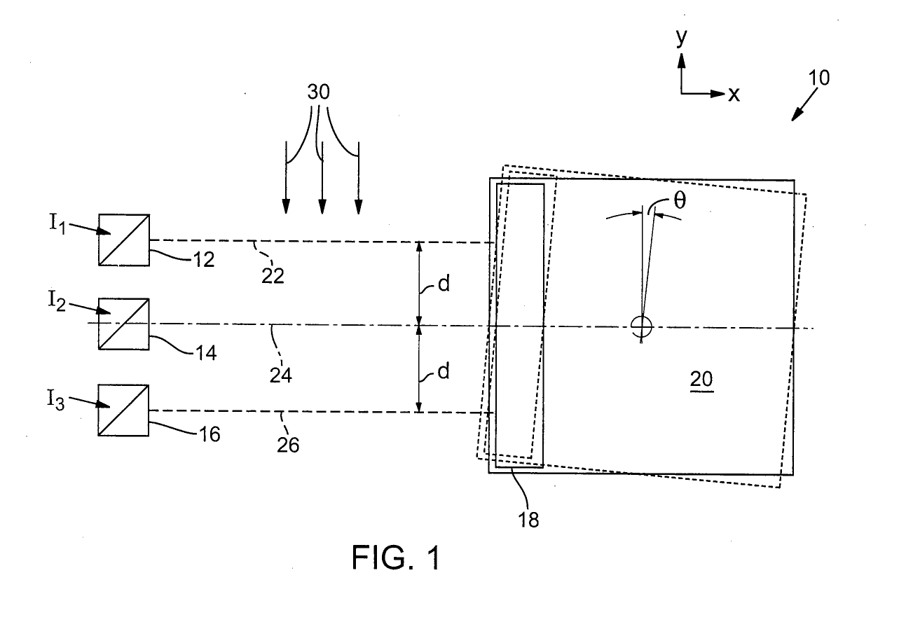

With respect to an interferometer involving a beam propagating through air, the ideal monitor of air-density or air-temperature fluctuation is the interferometer beam itself. However, since the stage is normally moving under servo control, a challenge is posed by the prospect of separating air-temperature-induced fluctuations from the stage motion. If additional interferometer beams are provided, a redundancy can be created, in which not all the beams are used by the stage-motion servo controller. For example, FIG. 1 shows a single-axis stage assembly 10. The stage assembly 10 comprises a movable platform 20, of which the position in the x-direction is monitored using three parallel interferometer beams I₁, I₂, I₃ that measure the distance between the respective interferometer heads 12, 14, 16 and a plane mirror 18 mounted on and movable with the platform 20.

The interferometers I₁, I₂, I₃ produce respective beams that, for simplicity, are assumed to be separated from each other by equal distances “d”. As the platform 20 stage travels in the x-direction, some yaw (rotation about a vertical axis) of the platform can occur. The yaw (indicated by the angle θ) is assumed to be about a vertical axis passing through a line co-located with the central interferometer beam 12. These assumptions are not intended to be limiting, but they do simplify the discussion.

The respective beam paths of the interferometers I₁, I₂, I₃ experience a current of air generated in the environmental chamber and/or a local duct. The interferometer signals at a time t can be represented as:

I₁=X+wθ+δ₁

I₂=X+δ₂

I₃=X−wθ+δ₃

where X is the true position of the stage platform 20, θ is the yaw angle of the platform, and δ₁, δ₂, and δ₃ are the respective air fluctuations in the beam paths 22, 24, 26 of the three interferometers I₁, I₂, I₃. The position of the platform 20 can be defined by the output of a single interferometer, say I₂, or by an average output of two or more of the interferometers I₁, I₂, I₃. The yaw is defined by a difference of two interferometer signals, say I₁−I₃. These two quantities (position and yaw) completely define the stage position in the x-direction (i.e., the stage-motion direction), and can be determined by two of the interferometers, leaving the third interferometer beam to provide redundancy that can be used to characterize air-temperature or other air-density fluctuations in the beam paths. With the three-interferometer arrangement shown in FIG. 1,

(I₁−I₂)=(X+wθ+δ₁)−(X+δ₂)=wθ+δ₁−δ₂, and (1)

(I₃−I₂)=(X−wθ+δ₃)−(X+δ₂)=−wθ+δ₃−δ₂ (2)

The quantity DX₃ (mutual signal fluctuation for three interferometers) can be defined as:

$$\begin{matrix}{DX}_{3} = ( {I}_{1} - {I}_{2} ) + ( {I}_{3} - {I}_{2} ) & ( 3 ) \\ = {I}_{1} + {I}_{3} - 2 {I}_{2} & ( 4 ) \\ = {δ}_{1} + {δ}_{3} - 2 {δ}_{2} . & ( 5 )\end{matrix}$$

Thus, the mutual signal fluctuation DX₃ represents the effects of only air-temperature or other air-density fluctuations (in the absence of stage-induced or body-induced vibrations) in the interferometer beams. In other words, the combination of stage-interferometer beams represented by DX₃ cancels out effects of stage motions, translations, and yaw. Note that, in the absence of these fluctuations, DX₃=0. Thus, the quantity DX₃ can serve as a sensitive measure of air fluctuations along the interferometer beams.

If stage yaw can be controlled by other means, either by mechanical constraint or, for an x-y stage, by using multiple interferometer beams on the orthogonal axis (the y-axis in the example of FIG. 1), then only two x-direction interferometer beams I₁, I₂ provide the desired redundancy for measuring air-density-related fluctuations. In this case, the fluctuations can be obtained from the difference DX₂ (mutual signal fluctuation for two interferometers):

$$\begin{matrix}{DX}_{2} = {I}_{1} - {I}_{2} & ( 6 ) \\ = ( X + {δ}_{1} ) - ( X + {δ}_{2} ) & ( 7 ) \\ = {δ}_{1} - {δ}_{2} & ( 8 )\end{matrix}$$

Again, stage motions, translations, and yaw are canceled out and, in the absence of these fluctuations, DX₂=0. Thus, the quantity DX₂ can serve as a sensitive measure of air fluctuations along the interferometer beams.

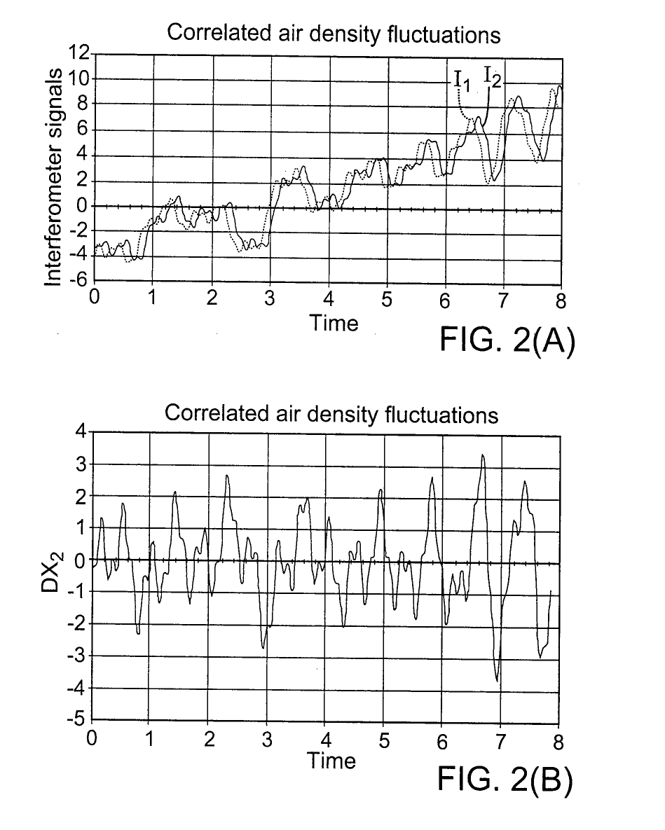

The analysis above made no assumptions about the air-flow properties. If the flow (arrows 30) of temperature-controlled air is provided at substantially right angles to the interferometer beams I₁, I₂, I₃, such that the plane containing the interferometer beams lies within the air flow, it is possible to extract fluctuations in individual interferometer beams from the mutual signal fluctuation DX₃ or DX₂. The extraction is based on the assumption (called the Taylor hypothesis in turbulence theory) that fluctuations in a downstream interferometer beam are similar to fluctuations in the upstream interferometer beam, but the fluctuation in the downstream beam is shifted in time by approximately the interferometer-beam separation (“d” in FIG. 1) divided by the average air-flow velocity. For example, FIG. 2(A) shows respective exemplary signals from two interferometers I₁, I₂. The signals were generated from a simple model and include a number of sinusoidal components. In addition, a ramp is present, representing stage motion. The signal from the interferometer I₂ is similar to the signal from the interferometer I₁, except that the I₂ signal is shifted in time relative to the signal I₁. The mutual signal fluctuation DX₂=I₁−I₂ is shown in FIG. 2(B). Note that the stage motion is removed. The mutual signal fluctuation DX₂ contains a substantial amount of data that, according to Equations (6)-(8), correspond directly to air-density or air-temperature fluctuations in the beam paths.

Regarding DX₃ for example, if a local flow of air proceeds, in the manner described above, from the interferometer I₁ to the interferometer I₂ and then to the interferometer I₃, a linear adaptive filter can be used to make, from DX₃, predictions of future fluctuations in the beam paths of the interferometers I₁, I₂, and I₃. Such a local flow may be produced with a local air duct. Details on use of a linear adaptive filter in this manner are discussed in U.S. Provisional Patent Application No. 60/856,630, filed on Nov. 3, 2006, entitled “Method and System For Predicting and Correcting Signal Fluctuations of an Interferometric Measuring Apparatus,” incorporated herein by reference. A similar analysis pertains to DX₂.

It is desirable to minimize the air-density fluctuations as much as possible, even when it is possible to correct for them. This because other optical sensors located near the lens or stages may be affected by air-density fluctuations as well. If the air flow is not as shown in FIG. 1, then the mutual signal fluctuations DX₃ or DX₂ from redundant combinations of interferometer beams would still depend only on the air fluctuations in the respective beams, but the air fluctuations in the individual beams would no longer be correlated and could not be determined. The mutual signal fluctuations nevertheless would be useful as a monitor for at least the air-handling system that directs a flow of air across the interferometer beams.

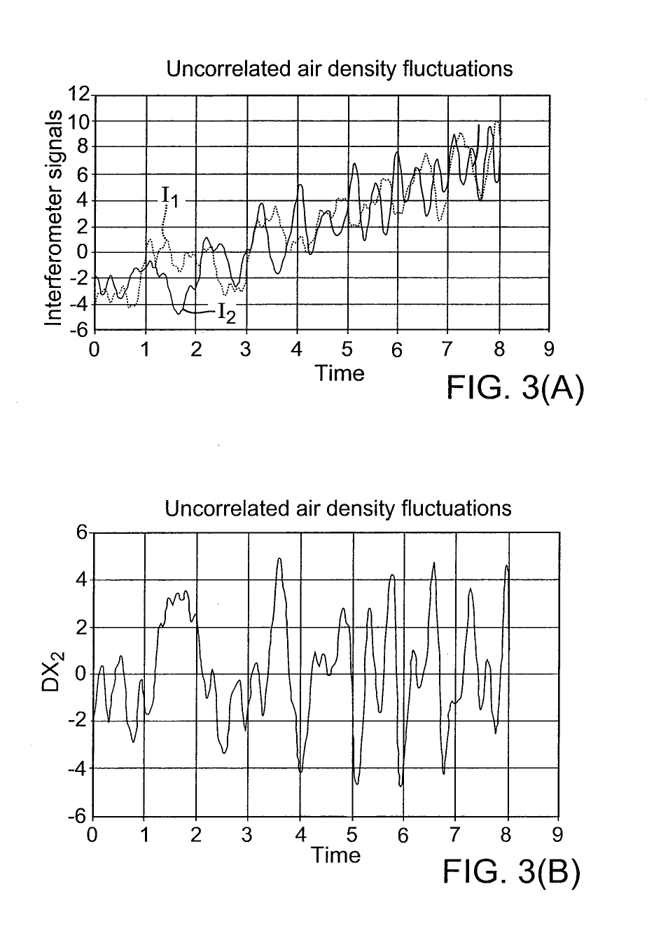

The mutual signal fluctuations DX₃, DX₂ are good measures of air-temperature fluctuations along the interferometer beams, and thus can be used as monitors for optimizing control of the air flow and temperature in the environmental chamber of the microlithography system and/or in the local ducts discharging air into the interferometer-beam paths. It is not necessary that the interferometer signals be correlated, as illustrated in the example of FIGS. 2(A)-2(B) showing fluctuations in the beams I₁ and I₂. Nearby interferometer beams experiencing uncorrelated or weakly correlated air flows can also be used. FIGS. 3(A)-3(B) show an example of weakly correlated air flows for I₁ and I₂. In addition a ramp is present, representing stage motion. An example of a weakly correlated air flow is a flow that is directed approximately normal to the plane containing the interferometer beams. Note that the profiles shown in FIGS. 3(A) and 3(B) are at least qualitatively similar to those in FIGS. 2(A) and 2(B), respectively. Thus, any group of interferometer beams, redundant in number, can serve as monitors of air fluctuations in the interferometer-beam paths.

In certain embodiments, time-averaged values of the mutual signal fluctuations DX₂ or DX₃ would be more useful than instantaneous signals. The moving average error (MA) of a stage would have a significant contribution from interferometer-beam fluctuations, so [symbol] DX₂ [symbol] or [symbol] DX₃ [symbol] (wherein [symbol] denotes an average) would be useful estimators for contributions of air-temperature fluctuations to a moving average. In other embodiments, RMS values or other measures of the same would be useful.

In view of the data content, the mutual signal fluctuations discussed above contain data reflective of what is occurring in the air-handling system of the microlithography system or other optical system in which the interferometers are DATE OF DEPOSIT: Feb. 13, 2008 located. Thus, the mutual signal fluctuations can be used for monitoring the air-handling system. This monitoring has substantial utility because: (1) it is real-time, (2) it is very sensitive, (3) it monitors air fluctuations where the interferometer beams actually are, (4) it can monitor the fluctuations as a function of stage position and motion, and (5) it is not limited to air-temperature fluctuations.

Regarding (5), above, the monitors described above are generally sensitive to any change in the refractive index of the air in the vicinity of the interferometers, which can be caused by factors other than air-temperature fluctuations. As mentioned above, changes in ambient conditions or the composition of the air tend to occur relatively slowly, and can be adequately monitored using point-source detectors, for example. However, one situation in which changes in air composition and/or density may occur over shorter times and/or occur inhomogeneously is in immersion microlithography, in which an immersion fluid is placed between the projection-optical system and the lithographic substrate. If some of the immersion fluid evaporates such that the vapor is conveyed into one or more of the interferometer beams, a beam fluctuation will occur, which will generate a stage-position error. The stage-position error may not be accurately or promptly detected by a point-source detector, such as a refractometer, located elsewhere in the environmental chamber of the microlithography system. The presence of the vapor can cause sudden and unexpected changes in the fluctuation profile of the monitor associated with the affected interferometer beams. This would flag the presence of an error, resulting in halting exposure. A fluctuation monitor as disclosed herein has substantial utility in detecting these types of interferometer-beam perturbations.

The need to control air handling, especially in the vicinity of the interferometer beams, is extremely important in microlithography systems in connection with one or more of the following: (a) providing thermal stability of mechanical components of the system, (b) achieving accurate stage metrology, (c) operating other sensors including optical sensors, and (d) achieving accuracy and precision of lithographic exposures. Previous approaches to addressing this need are discussed in, for example, U.S. Pat. No. 4,814,625 to Yabu and U.S. Pat. No. 5,870,197 to Sogard et al., both incorporated herein by reference.

The air-density-fluctuation monitor described here requires the signals from at least two interferometer beams. These beams must be redundant in the sense that the difference between them is not affected by motion of the stage. The stage motion is managed by a control system using interferometer signals, and possibly other sensors, as input. A stage moving in a horizontal plane is described by its x- and y-positions and its yaw, or angular orientation, about a vertical axis. Such a stage is described as a three-degrees-of-freedom (3DOF) stage. In principle, three interferometer measurements, e.g., two in the x-direction and one in the y-direction, are enough to describe the position and orientation of the stage. As we have seen, three x-interferometer beams can provide a pure measure of air-density fluctuations along the x-axis; the effects of stage motion in the x-direction and yaw can be eliminated. A single interferometer beam along the y-direction can also locate the stage position in y. If the stage-motion control is provided with two interferometer beam signals in the x-direction and one interferometer beam signal in the y-direction, the stage-motion control can unambiguously control position and orientation. The third x-axis interferometer beam is redundant. An additional y-axis interferometer beam is needed to provide a measure of air-density fluctuations along the y-axis. This example demonstrates that, if the interferometer beams are positioned appropriately, the number of interferometer beams needed by the control system to control the stage position and orientation is equal to the number of degrees of freedom of motion that are controlled. Additional interferometer beams are, in principle, redundant and can be combined appropriately with the interferometer beams used by the control system to provide the air-density-fluctuation signal.

The necessary redundancy can be achieved in a number of ways. Interferometer beams can always be added to any stage system to provide the needed redundancy for the air-density-fluctuation signal. It is desirable if the redundancy can be obtained with existing stage-interferometer systems, without adding extra beams. Additional beams are often present, which can be used to produce the air-density-fluctuation signal. For example, additional interferometer beams are sometimes provided to map small deviations from flatness of the stage mirrors. Or, additional interferometer beams are added that are co-linear with alignment sensors on a wafer stage, to reduce systematic errors associated with wafer-alignment procedures. Such interferometer beams are typically not used to control stage position; and when not performing their specialized functions, these additional interferometer beams are available to provide the redundancy required for the air-density-fluctuation signal.

Redundancy may be achieved in existing systems by other means as well. Wafer stages may require control of additional degrees of freedom to compensate for variations in shape and thickness of the wafer. The additional degrees of freedom may include pitch, roll, and height adjustment, and some of these degrees of freedom may be controlled with additional interferometer beams. All six degrees of freedom (6DOF) may be controlled in normal operation. For the purpose of making air-density-fluctuation measurements, for adjusting and optimizing the air-handling system, the servo-control of roll, pitch, and height (assuming all are controlled by interferometer beams) can be temporarily disabled, in software or hardware, and the stage operated as a 3DOF stage. The additional interferometer-beam redundancy makes this possible. Such activity interferes with normal operation of the lithography system, but occasional use of this technique (possibly during servicing intervals) may have little impact on throughput, while significantly improving performance. The air-handling system can only be monitored intermittently, rather than full-time. However, depending on the stability of the air-handling system properties, part-time optimization may provide much of the benefits of a full-time system.

Redundancy may also be achieved by positioning the stage at a desired location and then disabling the servo-control of course. Even in this limited mode of operation, considerable optimization of the air-handling system would be possible.

While specific reference was made to a wafer stage, the above discussion can apply equally to a reticle stage or other substrate stage.

Fluctuation monitors as described above provide better optimization, as well as the possibility of active control, of the air-handling system in a microlithography system, to minimize the incidence and/or magnitude of interferometer-beam fluctuations. As noted, there are typically several sources of air in the environmental chamber of the microlithography system. If the respective temperatures of these sources are not identical, mixing of the air in the environmental chamber can lead to substantial air-temperature fluctuations. The DX₂ and DX₃ signals, for example, discussed above allow very precise temperature adjustment of the air sources that can be performed in substantially real-time. Data from these signals also can be combined with data from fixed-path-length interferometer beams and/or with data from air-temperature sensors in the system for calibration or control purposes.

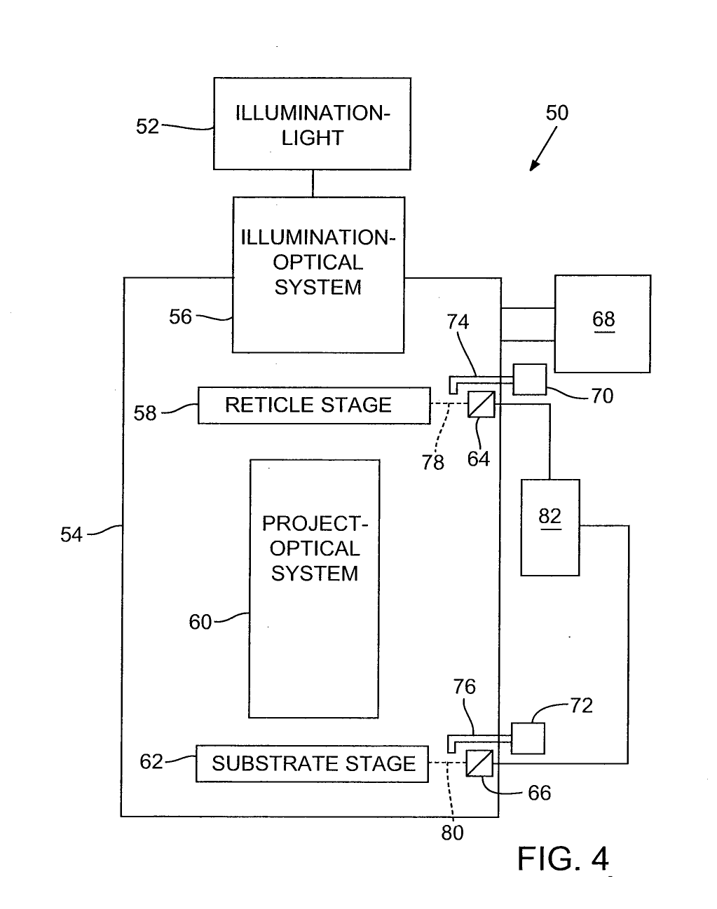

Referring to FIG. 4, certain portions of an exemplary microlithography system 50 are shown, including a source 52 of illumination light, an environmental chamber 54, an illumination-optical system 56, a reticle stage 58, a projection-optical system 60, a substrate (wafer) stage 62, a reticle-stage interferometer system 64, and a substrate-stage interferometer system 66. The air-handling system of this microlithography system typically comprises a source 68 of temperature-controlled air for the environmental chamber 54, a source 70 of temperature-controlled air for the reticle-stage interferometer system 64, and a source 72 of temperature controlled air for the substrate-stage interferometer system 66. From the interferometer-air sources 70, 72, respective local ducts 74, 76 provide approximately laminar flows of highly temperature-controlled air directed at the respective stage interferometer beams 78, 80. Although the “beams” 78, 80 are depicted as single beams, it will be understood that each “beam” 78, 80 represents multiple respective beams. The beams 78, 80 propagate in a direction (to the left in the figure, toward the respective stages 58, 62) through the atmosphere in the chamber 54. The quantity of beams 78, 80 in each location is sufficient for determining the position of the respective stage and is sufficiently redundant to produce a mutual signal fluctuation representative only of atmosphere-density fluctuations in the propagation path of the beams. Data from the interferometers 64, 66 are routed to a controller, computer, calculator, or the like 82 that calculates the mutual signal fluctuations from the interferometers.

As noted above, fluctuations in the optical-path length of the beams 78, 80 caused by fluctuations in air temperature or other air density, degrade the accuracy and precision in which stage position is determined. Air-temperature differences can arise from local heat sources in the environmental chamber 54 and/or from different set temperatures of the air delivered to the chamber and the local ducts 74, 76. Even though temperatures of air from different sources being supplied to the system are normally regulated to be substantially equal using in situ temperature sensors, significant errors can be introduced when performing calibrations of the sensors. These errors can substantially exceed the millikelvin temperature fluctuations of concern. Even if the air-source temperatures could be set to identical values during set-up, the different cycle times and temperature-oscillation amplitudes determined by their control systems will tend to create temperature differences over time. The respective behaviors of the different controllers, the different calibration errors of the temperature sensors, and the very small temperature variations that need to be controlled make this problem difficult to solve in conventional systems. Also, since the temperature variations of interest lie along the interferometer beams, whose lengths may be varying with stage position, discrete temperature sensors located elsewhere, even if they possess the required sensitivity, may not provide the information required to reduce these interferometer-beam fluctuations.

The fluctuation monitors discussed above employ combinations of stage-interferometer beams to cancel out the effects of stage motion, leaving only a signal determined by air-density fluctuations in the interferometer beams. As noted, a redundant number of interferometer beams is needed for producing such a signal. For example, if a single-axis stage is capable of linear motion and yaw that are both measured, then at least three interferometer beams (providing positional monitoring along the axis) are needed to isolate the fluctuation signal from the actual linear motions and yaw of the stage. If yaw can be prevented or if the yaw can be measured along a different axis than the linear-motion axis of the stage, then the necessary redundancy can be supplied by as few as two interferometer beams.

If the air flow across the interferometer beams does not have the properties described earlier, the DX signals still depend only on the air fluctuations but do not provide the fluctuations of single interferometer beams directly. Rather, in such instances, the DX signals provide a linear combination of the fluctuations experienced by multiple beams. Nevertheless, the DX signals are real-time, they are co-located with the interferometer beams, and they have sub-nanometer sensitivity. By using the RMS values of these signals, for example, determined over a relatively short period of time, near-perfect error signals are provided for active air-handler control systems configured to reduce the interferometer-beam fluctuations by making small adjustments to the local supplies of air to the interferometer beams. The control bandwidth of such an air-handler control system far exceeds the control bandwidth of conventional air handlers. The data produced by such an air-handler control system can be combined, if desired or required, with data obtained from reference-mirror interferometer beams, from air-temperature sensors, and/or from wavelength trackers, which may facilitate the making of absolute calibrations of the air-handler system.

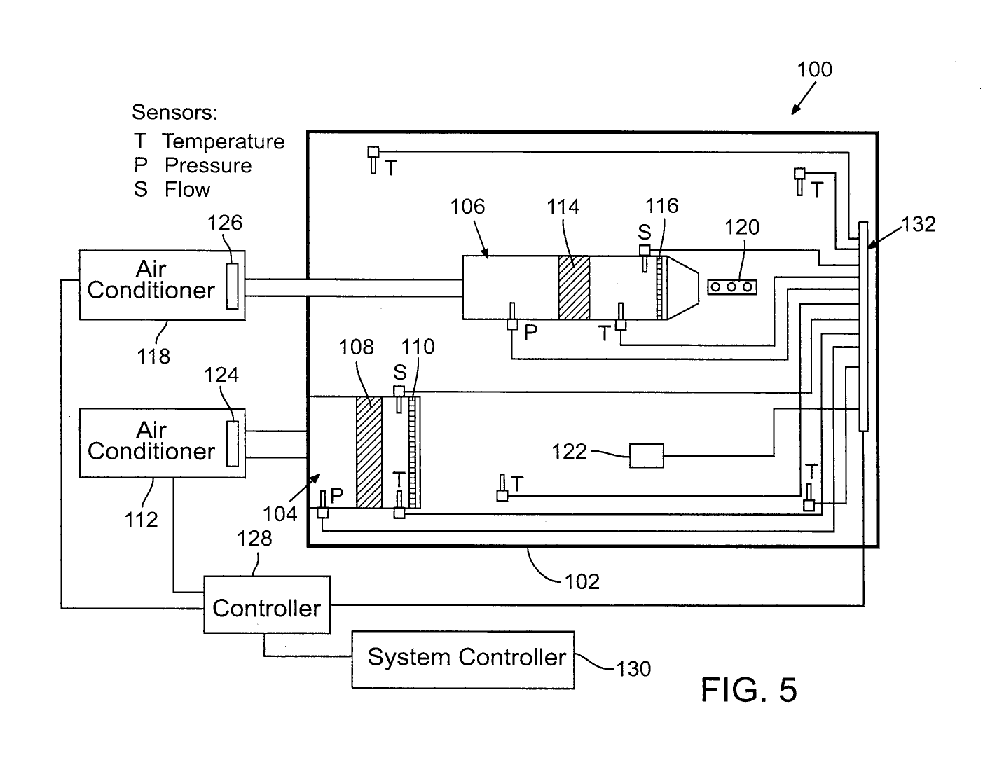

For comparison purposes, FIG. 5 schematically shows a conventional air-handler system 100 for a microlithography system that comprises an environmental chamber 102. Inside the environmental chamber 102 is a chamber-air source 104 and at least one “local laminar” (LL) air duct 106. The chamber-air source 104 comprises a HEPA (high-efficiency particulate air) filter 108, a heat-exchanger 110, a temperature sensor (“T”), a pressure sensor (“P”), and a flow sensor (“S”). The chamber-air source 104 is supplied with air by a respective air-conditioner 112 located outside the environmental chamber 102. The LL air duct 106 comprises a HEPA filter 114, a heat-exchanger 116, a temperature sensor (“T”), a pressure sensor (“P”), and a flow sensor (“S”). The LL air duct 106 is supplied with air by a respective air-conditioner 118 located outside the environmental chamber 102. The LL air duct 106 is disposed in the chamber 102 so as to deliver a laminar flow of air across interferometer beams 120, shown in cross-section. The environmental chamber 102 also includes a “weather station” 122 for monitoring various aspects (other than or in addition to the temperature) of the atmosphere in the chamber, and other temperature sensors (“T”) that are strategically placed to monitor air temperature at various locations in the chamber. Each of the air-conditioners 112, 118 includes a respective heater/chiller 124, 126, and the air-conditioners are connected to an air-controller 128 configured to operate the air-conditioners according to pre-set parameters. The air-controller 128 is connected to a main system controller 130 that integrates air control with other operational aspects of the microlithography system. The air-controller 128 is also connected to a sensor bus 132 located inside the environmental chamber 102. Connected to the sensor bus 132 are the temperature sensors (“T”), the pressure sensors (“P”), the flow sensors (“S”), and the weather station 122. The air-controller 128 thus receives data, via the sensor bus 132, from the various sensors and uses the data to regulate operation of the air-conditioners 112, 118 as required to deliver temperature-stabilized air to the chamber-air source 104 and LL air duct 106. Although local sensors (temperature, flow, and pressure of air) are located in the chamber-air source 104 and LL air duct 106, control of the air-handler system 100 is achieved by controlling the air-conditioner units 112, 118 that adjust air temperature, air humidity, and air velocity. Unfortunately, applying controls to the air-conditioning units 112, 118 does not provide a sufficiently stringent control of air temperature at the interferometer laser beams 120 (where strict control is most needed) to minimize air-density fluctuations in the beams. In other words, the bandwidth of this type of control system is too limited to achieve a desired level of control.

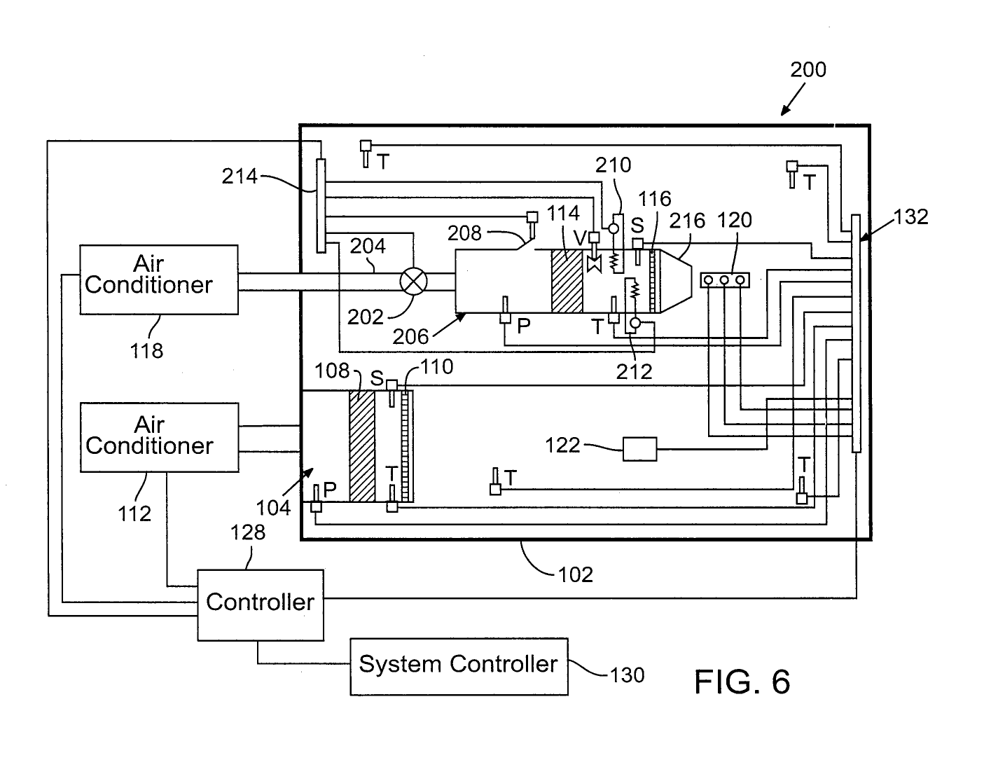

These shortcomings of a conventional system are addressed by various embodiments of an improved air-handler system 200, of which an embodiment is shown in FIG. 6, in which components that are identical to respective components shown in FIG. 5 have the same reference numerals. The differences of the system of FIG. 6, relative to FIG. 5, are located inside the environmental chamber 102. For example, in the embodiment of FIG. 6, a flow controller 202 is disposed in a conduit 204 extending between the LL air duct 206 and its air-conditioner 118. The LL air duct 206 now includes various actuators, including a pressure-control vent 208, an air-velocity sensor (“V”), a chiller unit 210, and a heater unit 212, all connected to an actuator bus 214 inside the environmental chamber 102. The beams of the interferometer 120, operating as an interferometer-beam-fluctuation sensor as described above, supply air-density-fluctuation data to the sensor bus 132. Also connected to the sensor bus 132 are the various temperature sensors (“T”), flow sensors (“S”), and pressure sensors (“P”) as in the system of FIG. 5. The sensor bus 132, now receiving data from the interferometers 120, is connected to the air-controller 128 for delivering data to the air-controller. The air-controller 128 also is connected to the actuator bus 214, by which the air-controller provides commands to the heater unit 212, the chiller unit 210, and the pressure-control vent 208. The air-controller 128 also is connected to the air-conditioner units 112, 118. Thus, the air-controller 128, controlled by the system controller 130, performs accurate sensing and fine adjustment of parameters associated with the air released from the LL air duct 206, relative to the parameters of air released from the chamber air source 104 and in the environmental chamber 102, to minimize the air-temperature fluctuations in the beam paths of the interferometers 120.

The number of actuators shown in the LL air-duct 206 of FIG. 6 is exemplary only. Other air-control systems may have more or fewer actuators. In the example embodiment of FIG. 6, the flow controller 202 is used for adjusting, under command of the air controller 128 via the actuator bus 214, the overall air-flow volume to the LL air duct 206. The pressure-control vent 208 is used for adjusting back-pressure in the LL air duct 206. The chiller 210 and heater units 212 are used for finely adjusting temperature of air just as the air is about to exit the LL air duct via the heat-exchanger 116. An adjustable vane (not shown) can be provided on or near the exhaust port 216 of the LL air-duct 206 to alter the direction of the air flow from the LL air-duct, if desired or required. In alternative embodiments, any of various other types of actuators can be used in place of the ones shown in the figure. The actuators desirably are nominally under real-time control, and only a few may be used in a given application.

As noted, the number of interferometer beams must be greater than the number required by the stage-position control system. I.e., there must be some redundancy or else the stage-position control system will actively work to eliminate the beam fluctuations by appropriate stage motion.

The embodiment 200 of FIG. 6 provides more local control of the air in the environmental chamber and provides a larger control bandwidth than the conventional system 100 shown in FIG. 5. Also, the very sensitive fluctuation monitor provides a much better error signal for the controllers 128, 130. For example, by adjusting the temperature of the air in the LL air duct 206 very finely to the temperature of air in the environmental chamber 102, fluctuations in the interferometer beams 120 are minimized.

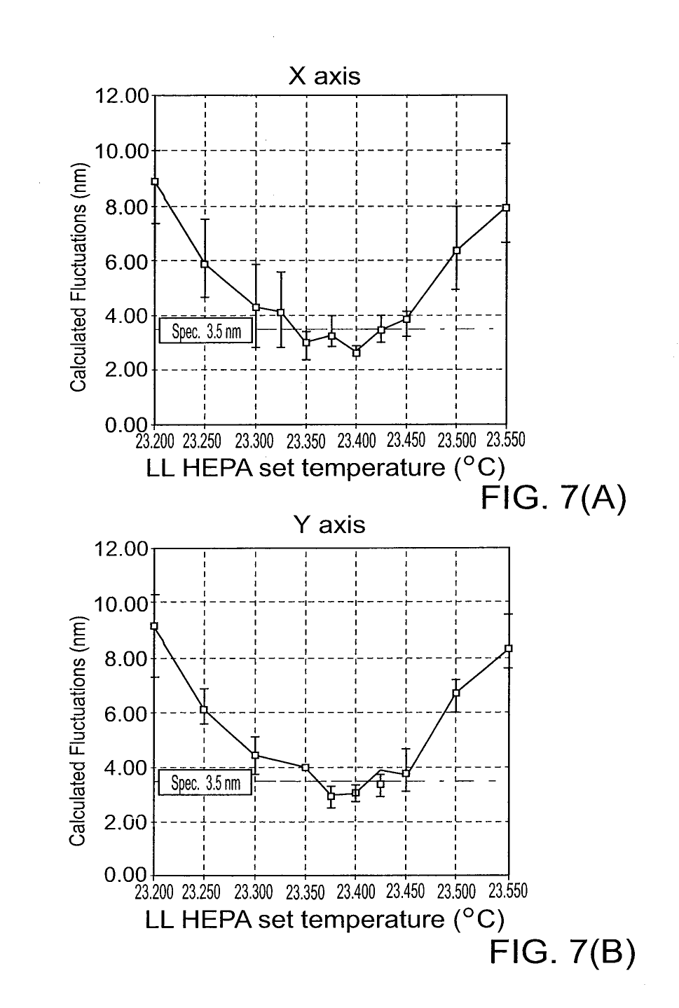

Exemplary data are shown in FIGS. 7(A)-7(B), depicting data along the x-direction (FIG. 7(A)) and along the y-direction (FIG. 7(B)). The ordinate of each figure is interferometer air-density fluctuation (nm), and the abscissa is the set temperature near the HEPA filter of the LL air duct. In this case, fluctuations from single interferometer beams are obtained by stopping the stage while measurements are taken. Thus, these data do not represent the interferometer-difference signals between several interferometers, which are the subject of this application, but they are very similar. Error bars are ±3σ. On the x-axis (FIG. 7(A)), controlling the temperature at the LL HEPA filter within 23.350° C. to 23.400° C. generally yielded beam fluctuations below a specified limit of 3.5 nm. On the y-axis (FIG. 7(B)), controlling the temperature at the LL HEPA filter within the same range generally yielded beam fluctuations below the specified limit of 3.5 nm. The use of such information greatly simplifies the initial setup and adjustment of the air-handling system.

The error signal produced by the interferometers is very sensitive, is real-time, and is co-located with the interferometer beams. It is available during motion of the respective stage, at various stage locations.

In FIG. 6 the air released from the LL air duct 206 can be optimized at different locations of the stage (not shown) and/or, if desired, during stage motion. Optimization can be maintained during normal operation of the stage. The large bandwidth and sensitive error signal would allow some degree of automatic set-up. Information from other sensors and from the weather station 122 may allow further control. In particular, information from other optical sensors, such as autofocus or alignment sensors (not shown), may be included, especially whenever the stage is at rest, to explore possible optimizations in which air-temperature-fluctuation effects in the respective sensor signals are also reduced.

Finding a point of optimization in a multidimensional control situation like this is possible, as illustrated by the results shown in FIGS. 7(A)-7(B). The conventional control system 100 of FIG. 5 is typically sufficient to bring the air-handling system to a condition where interferometer air-temperature fluctuations are <10 nm. The control system 200 of FIG. 6 provides substantially better performance. If desired or necessary, linear regression analysis may be adequate to achieve the minimum.

Using an interferometer air-fluctuation monitor as described herein, it is possible to provide a lithography-tool air-handling system with much greater sensitivity and control bandwidth. This invention also provides real-time minimization of air-density fluctuations in interferometer beams. Minimization can be maintained at different stage locations and during stage motion. Finally, the invention provides automation of the set-up of the air-handler system.

### Lithography System

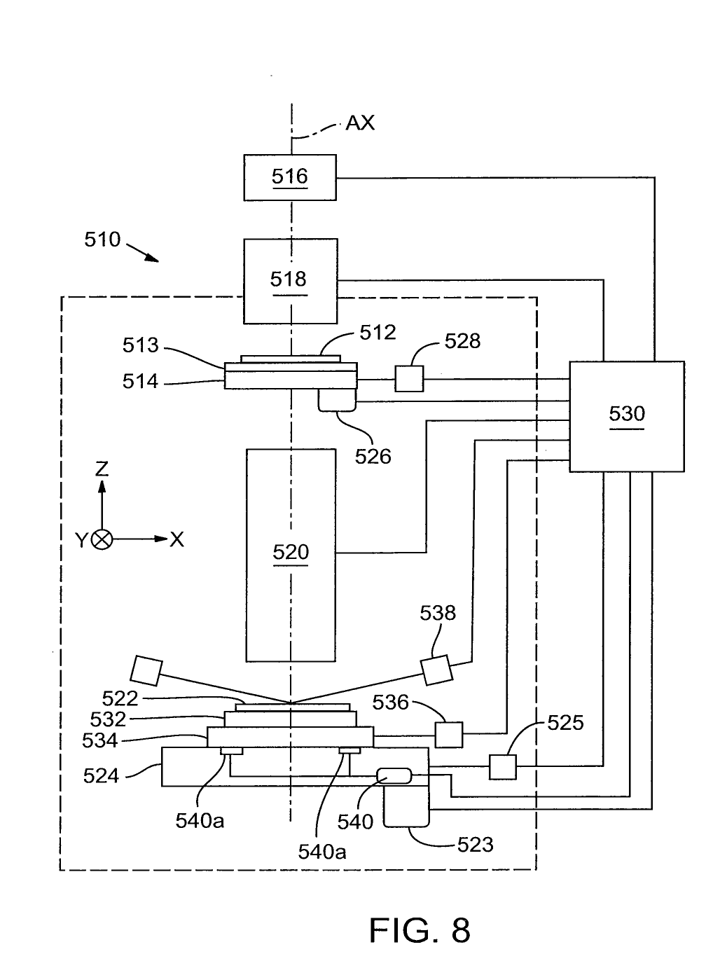

An exemplary microlithography system 510 (generally termed an “exposure system”) with which any of the foregoing embodiments can be used is depicted in FIG. 8, which depicts an example of a projection-exposure system. A pattern is defined on a reticle (sometimes termed a “mask”) 512 mounted on a reticle stage 514. The reticle 512 is “illuminated” by an energy beam (e.g., DUV light) produced by a source 516 and passed through an illumination-optical system 518. As the energy beam passes through the reticle 512, the beam acquires an ability to form an image, of the illuminated portion of the reticle 512, downstream of the reticle. The beam passes through a projection-optical system 520 that focuses the beam on a sensitive surface of a substrate 522 held on a substrate stage (“wafer stage” or “wafer XY stage”) 524. As shown in the figure, the source 516, illumination-optical system 518, reticle stage 514, projection-optical system 520, and wafer stage 524 generally are situated relative to each other along an optical axis AX. The reticle stage 514 is movable at least in the x- and θ_{z}-directions using a stage actuator 526 (e.g., linear motor), and the positions of the reticle stage 514 in the x- and y-directions are detected by respective interferometers 528. Each of the interferometers 528 actually comprises a sufficient number of redundant interferometers to provide respective air-fluctuation monitors as described above. The system 510 is controlled by a system controller (computer) 530.

The substrate 522 (also termed a “wafer”) is mounted on the wafer stage 524 by a wafer chuck 532 and wafer table 534 (also termed a “leveling table”). The wafer stage 524 not only holds the wafer 522 for exposure (with the resist facing in the upstream direction) but also provides for controlled movements of the wafer 522 in the x- and y-directions as required for exposure and for alignment purposes. The wafer stage 524 is movable by a suitable wafer-stage actuator 523 (e.g., linear motor), and positions of the wafer stage 524 in the X- and Y-directions are determined by respective interferometers 525. The wafer table 534 is used to perform fine positional adjustments of the wafer chuck 532 (holding the wafer 522), relative to the wafer stage 524, in each of the x-, y-, and z-directions. Positions of the wafer table 534 in the x- and y-directions are determined by respective wafer-stage interferometers 536. Each of the interferometers 536 actually comprises a sufficient number of redundant interferometers to provide respective air-fluctuation monitors as described above.

The wafer chuck 532 is configured to hold the wafer 522 firmly for exposure and to facilitate presentation of a planar sensitive surface of the wafer 522 for exposure. The wafer 522 usually is held to the surface of the wafer chuck 532 by vacuum, although other techniques such as electrostatic attraction can be employed under certain conditions. The wafer chuck 532 also facilitates the conduction of heat away from the wafer 522 that otherwise would accumulate in the wafer during exposure.

Movements of the wafer table 534 in the z-direction (optical-axis direction) and tilts of the wafer table 34 relative to the z-axis (optical axis AX) typically are made in order to establish or restore proper focus of the image, formed by the projection-optical system 520, on the sensitive surface of the wafer 522. “Focus” relates to the position of the exposed portion of the wafer 522 relative to the projection-optical system 520. Focus usually is determined automatically, using an auto-focus (AF) device 538. The AF device 538 produces data that is routed to the system controller 530. If the focus data produced by the AF device 538 indicates existence of an out-of-focus condition, then the system controller 530 produces a “leveling command” that is routed to a wafer-table controller 540 connected to individual wafer-table actuators 540a. Energization of the wafer-table actuators 540a results in movement and/or tilting of the wafer table 534 serving to restore proper focus.

The exposure system 510 can be any of various types. For example, as an alternative to operating in a “step-and-repeat” manner characteristic of steppers, the exposure system can be a scanning-type apparatus operable to expose the pattern from the reticle 512 to the wafer 522 while continuously scanning both the reticle 512 and wafer 522 in a synchronous manner. During such scanning, the reticle 512 and wafer 522 are moved synchronously in opposite directions perpendicular to the optical axis Ax. The scanning motions are performed by the respective stages 514, 524.

In contrast, a step-and-repeat exposure apparatus performs exposure only while the reticle 512 and wafer 522 are stationary. If the exposure apparatus is an “optical lithography” apparatus, the wafer 522 typically is in a constant position relative to the reticle 512 and projection-optical system 520 during exposure of a given pattern field. After the particular pattern field is exposed, the wafer 522 is moved, perpendicularly to the optical axis AX and relative to the reticle 512, to place the next field of the wafer 522 into position for exposure. In such a manner, images of the reticle pattern are sequentially exposed onto respective fields on the wafer 522.

Exposure systems as provided herein are not limited to microlithography systems for manufacturing microelectronic devices. As a first alternative, for example, the exposure system can be a microlithography system used for transferring a pattern for a liquid-crystal display (LCD) onto a glass plate. As a second alternative, the exposure system can be a microlithography system used for manufacturing thin-film magnetic heads. As a third alternative, the exposure system can be a proximity-microlithography system used for exposing, for example, a mask pattern. In this alternative, the mask and substrate are placed in close proximity with each other, and exposure is performed without having to use a projection-optical system 520.

The principles set forth in the foregoing disclosure further alternatively can be used with any of various other apparatus, including (but not limited to) other microelectronic-processing apparatus, machine tools, metal-cutting equipment, and inspection apparatus.

In any of various exposure systems as described above, the source 516 (in the illumination-optical system 518) of illumination “light” can be, for example, a g-line source (436 nm), an i-line source (365 nm), a KrF excimer laser (248 nm), an ArF excimer laser (193 nm), or an F₂ excimer laser (157 nm). Alternatively, the source 516 can be of any other suitable exposure light.

With respect to the projection-optical system 520, if the illumination light comprises far-ultraviolet radiation, then the constituent lenses are made of UV-transmissive materials such as quartz and fluorite that readily transmit ultraviolet radiation. If the illumination light is produced by an F₂ excimer laser or EUV source, then the lenses of the projection-optical system 520 can be either refractive or catadioptric, and the reticle 512 desirably is a reflective type. If the illumination light is in the vacuum ultraviolet (VUV) range (less than 200 nm), then the projection-optical system 520 can have a catadioptric configuration with beam splitter and concave mirror, as disclosed for example in U.S. Pat. Nos. 5,668,672 and 5,835,275, incorporated herein by reference. The projection-optical system 520 also can have a reflecting-refracting configuration including a concave mirror but not a beam splitter, as disclosed in U.S. Pat. Nos. 5,689,377 and 5,892,117, incorporated herein by reference.

Either or both the reticle stage 514 and wafer stage 524 can include respective linear motors for achieving the motions of the reticle 512 and wafer 522, respectively, in the x-axis and y-axis directions. The linear motors can be air-levitation types (employing air bearings) or magnetic-levitation types (employing bearings based on the Lorentz force or a reactance force). Either or both stages 514, 524 can be configured to move along a respective guide or alternatively can be guideless. See U.S. Pat. Nos. 5,623,853 and 5,528,118, incorporated herein by reference.

Further alternatively, either or both stages 514, 524 can be driven by a planar motor that drives the respective stage by electromagnetic force generated by a magnet unit having two-dimensionally arranged magnets and an armature-coil unit having two-dimensionally arranged coils in facing positions. With such a drive system, either the magnet unit or the armature-coil unit is connected to the respective stage and the other unit is mounted on a moving-plane side of the respective stage.

Movement of a stage 514, 524 as described herein can generate reaction forces that can affect the performance of the exposure apparatus. Reaction forces generated by motion of the wafer stage 524 can be shunted to the floor (ground) using a frame member as described, e.g., in U.S. Pat. No. 5,528,118, incorporated herein by reference. Reaction forces generated by motion of the reticle stage 514 can be shunted to the floor (ground) using a frame member as described in U.S. Pat. No. 5,874,820, incorporated herein by reference.

An exposure system such as any of the various types described above can be constructed by assembling together the various subsystems, including any of the elements listed in the appended claims, in a manner ensuring that the prescribed mechanical accuracy, electrical accuracy, and optical accuracy are obtained and maintained. For example, to maintain the various accuracy specifications, before and after assembly, optical-system components and assemblies are adjusted as required to achieve maximal optical accuracy. Similarly, mechanical and electrical systems are adjusted as required to achieve maximal respective accuracies. Assembling the various subsystems into an exposure apparatus requires the making of mechanical interfaces, electrical-circuit wiring connections, and pneumatic plumbing connections as required between the various subsystems. Typically, constituent subsystems are assembled prior to assembling the subsystems into an exposure apparatus. After assembly of the apparatus, system adjustments are made as required for achieving overall system specifications in accuracy, etc. Assembly at the subsystem and system levels desirably is performed in a clean room where temperature and humidity are controlled.

### Semiconductor-Device Fabrication

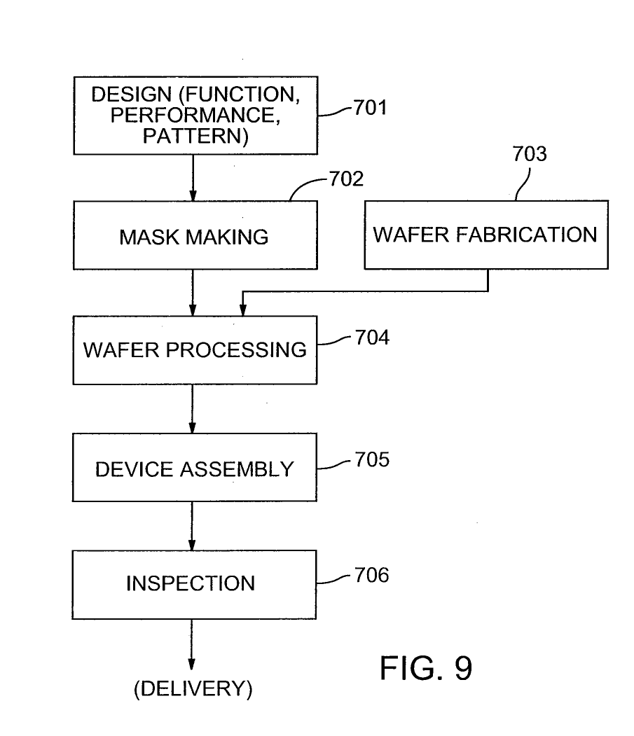

Semiconductor devices can be fabricated by processes including microlithography steps performed using a microlithography system as described above. Referring to FIG. 9, in step 701 the function and performance characteristics of the semiconductor device are designed. In step 702 a reticle defining the desired pattern is designed according to the previous design step. Meanwhile, in step 703, a substrate (wafer) is made and coated with a suitable resist. In step 704 the reticle pattern designed in step 702 is exposed onto the surface of the substrate using the microlithography system. In step 705 the semiconductor device is assembled (including “dicing” by which individual devices or “chips” are cut from the wafer, “bonding” by which wires are bonded to the particular locations on the chips, and “packaging” by which the devices are enclosed in appropriate packages for use). In step 706 the assembled devices are tested and inspected.

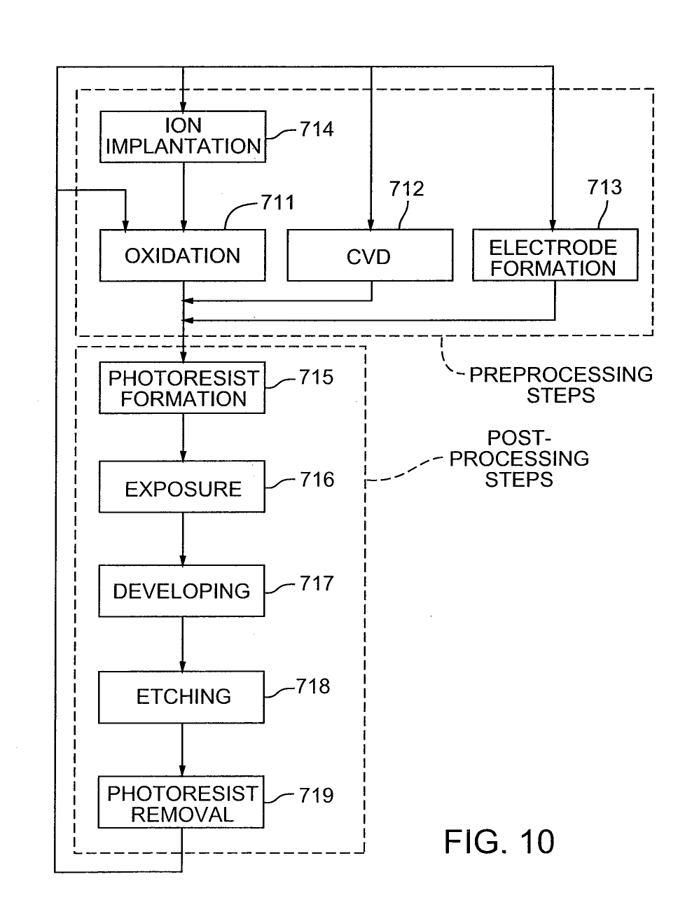

Representative details of a wafer-processing process including a microlithography step are shown in FIG. 10. In step 711 (oxidation) the wafer surface is oxidized. In step 712 (CVD) an insulative layer is formed on the wafer surface. In step 713 (electrode formation) electrodes are formed on the wafer surface by vapor deposition for example. In step 714 (ion implantation) ions are implanted in the wafer surface. These steps 711-714 constitute representative “pre-processing” steps for wafers, and selections are made at each step according to processing requirements.

At each stage of wafer processing, when the pre-processing steps have been completed, the following “post-processing” steps are implemented. A first post-process step is step 715 (photoresist formation) in which a suitable resist is applied to the surface of the wafer. Next, in step 716 (exposure), the microlithography system described above is used for lithographically transferring a pattern from the reticle to the resist layer on the wafer. In step 717 (development) the exposed resist on the wafer is developed to form a usable mask pattern, corresponding to the resist pattern, in the resist on the wafer. In step 718 (etching), regions not covered by developed resist (i.e., exposed material surfaces) are etched away to a controlled depth. In step 719 (photoresist removal), residual developed resist is removed (“stripped”) from the wafer.

Formation of multiple interconnected layers of circuit patterns on the wafer is achieved by repeating the pre-processing and post-processing steps as required. Generally, a set of pre-processing and post-processing steps are conducted to form each layer.

Whereas the disclosure was set forth in the context of various representative embodiments, it will be understood that the scope of the invention is not limited to those embodiments. On the contrary, the invention is intended to encompass all modifications, alternatives, and equivalents falling within the spirit and scope of the invention, as defined by the appended claims.

What is claimed is:

1. A sensor of density fluctuations in an atmosphere, the sensor comprising:
multiple interferometers producing respective beams propagating in a direction through an atmosphere, the interferometers being of a quantity that is at least one more than necessary for determining position of an object in the direction; and
a processor connected to the interferometers so as to receive respective signals from the interferometers and configured to determine, from the interferometer signals, a mutual signal fluctuation that is a function of atmosphere-density fluctuations encountered by the propagating beams in their respective beam paths and sensed by the interferometers.

2. The sensor of claim 1, wherein the beams propagate in the direction to an object in the direction.

3. The sensor of claim 2, further comprising a mirror situated on the object to reflect the interferometer beams.

4. The sensor of claim 1, wherein:
the interferometers comprise a first and a second interferometer;
the first interferometer is situated and configured to determine the position of the object in the direction;
the second interferometer is a redundant interferometer; and
the processor is configured to determine the mutual signal fluctuation from the respective signals from the first and second interferometers.

5. The sensor of claim 4, wherein the first and second interferometers are situated and configured to determine position and yaw of the object.

6. The sensor of claim 1, wherein:
the interferometers comprise a first, a second, and a third interferometer;
the first and second interferometers are situated and configured to determine the position of the object in the direction;
the third interferometer is a redundant interferometer; and
the processor determines the mutual signal fluctuation from the respective signals from the first, second, and third interferometers.

7. A device for determining a position of an object that is movable in a direction, the device comprising:
a mirror mounted to the object;
multiple interferometers of which respective beams propagate in a direction through an atmosphere to the mirror, the interferometers being of a quantity that is at least one more than necessary for determining position of the object in the direction; and
a processor connected to the interferometers, the processor being configured to (a) receive respective signals from the interferometers; (b) determine, from the interferometer signals, the position of the object in the direction; (c) determine, from the interferometer signals, a mutual signal fluctuation that is a function of atmosphere-density fluctuations encountered by the beams and sensed by the interferometers; and (d) based on the mutual signal fluctuation, remove effects of atmosphere-density fluctuations on the determined position.

8. The device of claim 7, wherein:
the interferometers comprise first and second interferometers;
the first interferometer is situated and configured to determine position of the object in the direction; and
the second interferometer is a redundant interferometer.

9. The device of claim 7, wherein:
the interferometers comprise first, second, and third interferometers;
the first and second interferometers are situated to determine the position of the object in the direction; and
the third interferometer is a redundant interferometer.

10. The device of claim 7, wherein:
the atmosphere is air; and
the atmosphere-density fluctuations comprise air-temperature fluctuations.

11. The device of claim 10, further comprising an air-flow device configured to release a flow of air across the interferometer beams.

12. The device of claim 11, wherein the air-flow device is configured to release the flow of air at a right angle to the direction.

13. An exposure system, comprising:
an optical system;
a stage that is movable in a direction relative to the optical system;
multiple interferometers producing respective beams propagating in the direction through an atmosphere to the stage, the interferometers being of a quantity that is at least one more than necessary for determining position of the stage in the direction; and
a processor connected to the interferometers so as to receive respective signals from the interferometers and configured to determine, from the interferometer signals, a mutual signal fluctuation that is a function of atmosphere-density fluctuations encountered by the propagating beams in their respective beam paths and sensed by the interferometers.

14. The system of claim 13, further comprising a mirror mounted to the stage, wherein the beams propagating in the direction reflect from the mirror.

15. The system of claim 14, wherein the processor is further configured to remove, based on the mutual signal fluctuation, effects of atmosphere-density fluctuations on the determined position of the stage.

16. The system of claim 13, configured as a microlithography system.

17. A method for monitoring an interferometer-beam path for fluctuations in density of an atmosphere in the path, the method comprising:
directing respective interferometer beams from multiple interferometers in a direction through the atmosphere to an object, the interferometers being of a quantity that is at least one more than necessary for determining a position of the object in the direction; and
from respective signals from the interferometers, determining a mutual signal fluctuation, the mutual signal fluctuation being a function of atmosphere-density fluctuations encountered by the propagating beams and sensed by the interferometers.

18. The method of claim 17, further comprising:
determining the position of the object using a first interferometer; and
using a second interferometer as a redundant interferometer for determining the position.

19. The method of claim 17, further comprising:
determining the position of the object using first and second interferometers; and
using a third interferometer as a redundant interferometer for determining the position.

20. The method of claim 17, further comprising directing a flow of air across the interferometer beams.

21. A method for correcting a signal fluctuation due to a density variation in an atmosphere in an optical path of an interferometer device for measuring position of an object that is movable in a direction, the method comprising:
propagating respective beams of multiple interferometers in the direction through the atmosphere to the object, the multiple interferometers being of a quantity that is at least one more than necessary for determining a position of the object in the direction;
receiving respective positional signals from the interferometers and determining therefrom a preliminary position of the object;
from the positional signals, determining a mutual signal fluctuation that is a function of atmosphere-density fluctuations encountered by the beams and sensed by the interferometers; and
subtracting the mutual signal fluctuation from the preliminary signal to produce an actual-position signal.
